(19) United States
(12) Patent Application Publication
(10) Pub. No.: US 2016/0349890 A1
(43) Pub. Date: Dec. 1, 2016

(54) EMBEDDED TOUCH DISPLAY PANEL

(71) Applicant: HON HAI PRECISION INDUSTRY CO., LTD., New Taipei (TW)

(72) Inventors: YU-FU WENG, New Taipei (TW); CHIEN-WEN LIN, New Taipei (TW); CHIA-LIN LIU, New Taipei (TW)

(21) Appl. No.: 14/948,983

(22) Filed: Nov. 23, 2015

(30) Foreign Application Priority Data
May 28, 2015 (TW) 104117247

(51) Int. Cl. G06F 3/041; G02F 1/1335; G02F 1/1368; G02F 1/1333; G06F 1/16

(52) U.S. Cl. CPC G06F 3/0412; G02F 1/13338; G06F 1/16; G02F 1/1368; G02F 1/133514; G02F 1/133528; G06F 2203/04112

(57) ABSTRACT

An embedded touch display panel includes a number of touch sensing electrodes arranged in a touch sensing layer of the embedded touch display panel. The number of touch sensing electrodes is positioned in a display area of the touch display panel and includes a number of central touch sensing electrodes arranged in a central portion of the display area and a number of peripheral touch sensing electrodes arranged in a peripheral portion of the display area. The peripheral display area surrounds the central display area, and the number of peripheral touch sensing electrodes is smaller in size than the number of central touch sensing electrodes.

### CROSS-REFERENCE TO RELATED APPLICATIONS

This application claims priority to Taiwanese Patent Application No. TW104117247 filed on May 28, 2015, the contents of which are incorporated by reference herein.

### FIELD

The subject matter herein generally relates to embedded touch display panels, and more particularly to an embedded touch display panel having touch sensing electrodes of different sizes.

### BACKGROUND

Generally, an embedded touch display panel includes a plurality of touch sensing electrodes to detect touch operations thereon.

### BRIEF DESCRIPTION OF THE DRAWINGS

Implementations of the present technology will now be described, by way of example only, with reference to the attached figures.

FIG. 1 is an isometric view of a first embodiment of an embedded touch display panel.

FIG. 2 is a top plan view of a touch sensing layer of FIG. 1.

FIG. 3 is a top plan view of a thin film transistor driving layer and a pixel electrode layer of FIG. 1.

FIG. 4 is an isometric view of a second embodiment of an embedded touch display panel.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

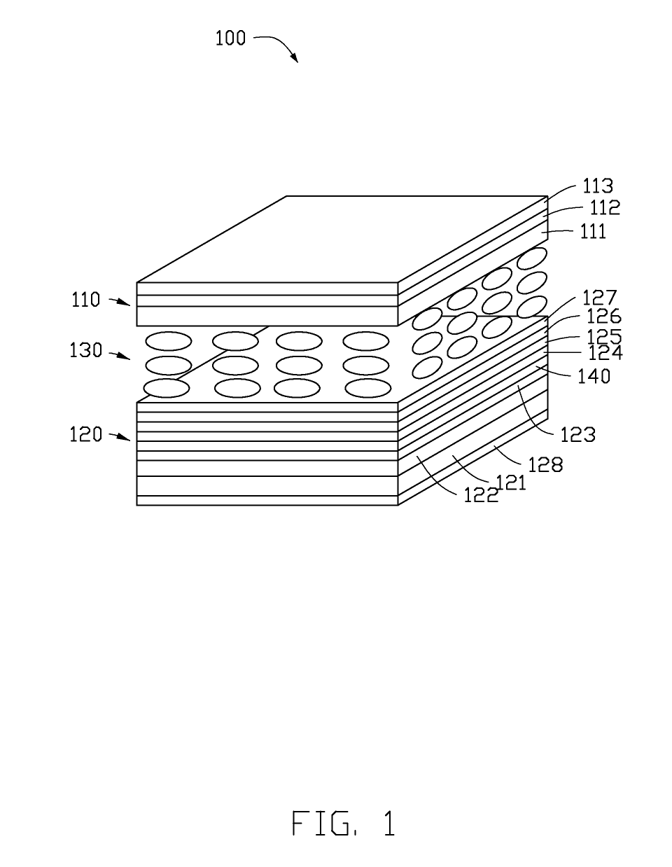

FIG. 1 illustrates a first embodiment of an embedded touch display panel 100. The embedded touch display panel 100 can include a first substrate 110, a second substrate 120, and a liquid crystal layer 130. The liquid crystal layer 130 can be located between the first substrate 110 and the second substrate 120. In at least one embodiment, the first substrate 110 is a color filter substrate, and the second substrate 120 is a thin film transistor substrate. The second substrate 120 can include a touch sensing layer 140.

The first substrate 110 can include a first base layer 111, a color filter layer 112, and a first polarizing layer 113. The color filter layer 112 can be located on a side of the first substrate 110 facing away from the liquid crystal layer 130. The first polarizing layer 113 can be located on a side of the color filter layer 112 facing away from the liquid crystal layer 130.

The second substrate 120 can include a second base layer 121, a thin film transistor driving layer 122, a first insulating layer 123, a second insulating layer 124, a metal conducting layer 125, a third insulating layer 126, a pixel electrode layer 127, and a second polarizing layer 128.

The thin film transistor driving layer 122 can be located on a side of the second base layer 121 facing the liquid crystal layer 130. The first insulating layer 123 can be located between the thin film transistor driving layer 122 and the touch sensing layer 140 and electrically insulate the touch sensing layer 140 from the thin film transistor driving layer 122. The second insulating layer 124 can be located on a side of the touch sensing layer 140 facing the liquid crystal layer 130. The metal conducting layer 125 can be located on a side of the second insulating layer 124 facing the liquid crystal layer 130 and be electrically insulated from the touch sensing layer 140 through the second insulating layer 124. The third insulating layer 126 can be located on a side of the metal conducting layer 125 facing the liquid crystal layer 130. The pixel electrode layer 127 can be located on a side of the third insulating layer 126 facing the liquid crystal layer 130 and electrically insulated from the metal conducting layer 125 through the third insulating layer 126. The second polarizing layer 128 can be located on a side of the second base layer 121 facing away from the liquid crystal layer 130.

In at least one embodiment, the touch sensing layer 140 can operate in a touch sensing mode and a display mode. In the touch sensing mode, the touch sensing layer 140 can detect touch operations on the embedded touch display panel 100. In the display mode, the touch sensing layer 140 can operate as a common electrode layer to cooperate with the pixel electrode layer 127 to drive the liquid crystal layer 130 to display.

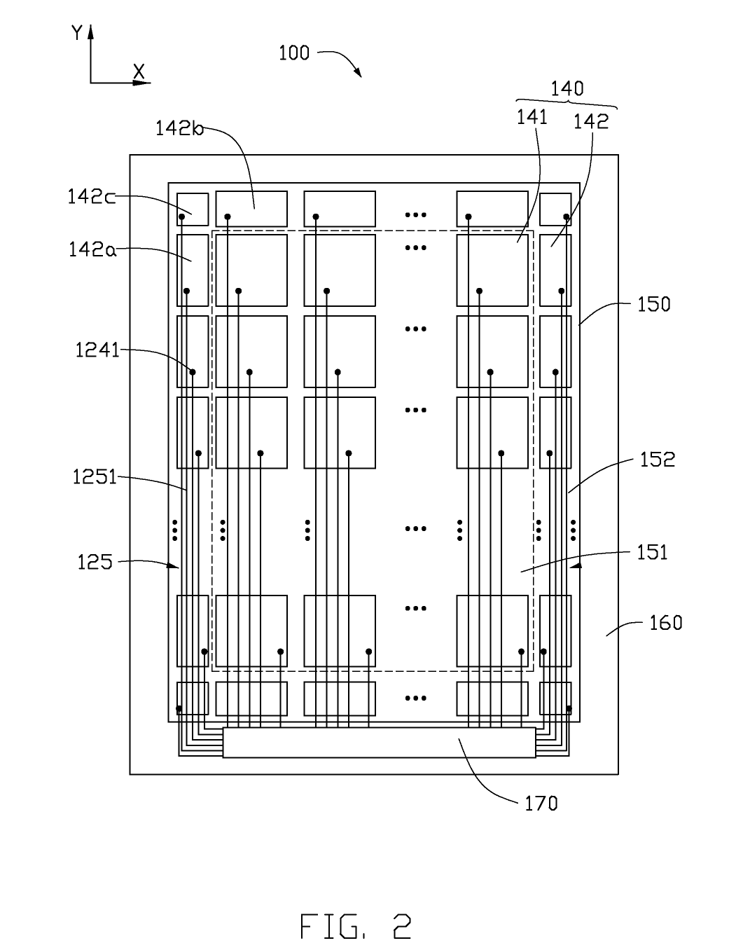

As illustrated in FIG. 2, the embedded touch display panel 100 can include a display area 150 and a non-display area 160. A driving chip 170 can be positioned in the non-display area 160. The display area 150 can include a central portion 151 and a peripheral portion 152. The peripheral portion 152 can surround the central portion 151. The touch sensing layer 140 can include a plurality of touch sensing electrodes. The plurality of touch sensing electrodes can include a plurality of central touch sensing electrodes 141 and a plurality of peripheral touch sensing electrodes 142. The plurality of central touch sensing electrodes 141 can be positioned in the central portion 151 of the display area 150, and the plurality of peripheral touch sensing electrodes 142 can be positioned in the peripheral portion 152 of the display area 150. A size of the plurality of peripheral touch sensing electrodes 142 can be smaller than a size of the plurality of central touch sensing electrodes 141.

The plurality of central touch sensing electrodes 141 can be arranged in a matrix as a plurality of rows and columns. The plurality of rows can extend along a first direction X, and the plurality of columns can extend along a second direction Y. The plurality of peripheral touch sensing electrodes 142 can include a plurality of first peripheral touch sensing electrodes 142a, a plurality of second peripheral touch sensing electrodes 142b, and a plurality of third peripheral touch sensing electrodes 142c.

In at least one embodiment, a size of the plurality of first peripheral touch sensing electrodes 142a along the first direction X can be smaller than a size of the plurality of central touch sensing electrodes 141, and a size of the plurality of first peripheral touch sensing electrodes 142a along the second direction Y can be equal to a size of the plurality of central touch sensing electrodes 141 along the second direction Y. In at least one embodiment, the plurality of first peripheral touch sensing electrodes 142a can be arranged along the same rows as the plurality of central touch sensing electrodes 141. In at least one embodiment, a distance between every two adjacent central touch sensing electrodes 141 is the same and larger than a distance between the first peripheral touch sensing electrodes 142a and the central touch sensing electrode 141 located most adjacent to the first peripheral touch sensing electrodes 142a. In at least one embodiment, the size of the plurality of first peripheral touch sensing electrodes 142aalong the first direction X is about 1.5 micrometers, and the size of the plurality of first peripheral touch sensing electrodes 142a and the plurality of central touch sensing electrodes 141 along the second direction Y is about 5 micrometers.

In at least one embodiment, a size of the plurality of second peripheral touch sensing electrodes 142b along the second direction Y can be smaller than a size of the plurality of central touch sensing electrodes 141, and a size of the plurality of second peripheral touch sensing electrodes 142b along the first direction X can be equal to the size of the plurality of central touch sensing electrodes 141 along the first direction X. In at least one embodiment, the plurality of second peripheral touch sensing electrodes 142b can be arranged along the same columns as the plurality of central touch sensing electrodes 141. In at least one embodiment, the distance between every two adjacent central touch sensing electrodes 141 is the same and larger than a distance between the second peripheral touch sensing electrodes 142b and the central touch sensing electrode 141 located most adjacent to the second peripheral touch sensing electrodes 142b. In at least one embodiment, the size of the plurality of second peripheral touch sensing electrodes 142b along the second direction Y is about 1.5 micrometers, and the size of the plurality of second peripheral touch sensing electrodes 142b and the plurality of central touch sensing electrodes 141 along the first direction X is about 5 micrometers.

The plurality of third peripheral touch sensing electrodes 142c can be arranged in the corners of the peripheral display area 152. In at least one embodiment, a size of the plurality of third peripheral touch sensing electrodes 142c along the first direction X can be smaller than the size of the plurality of central touch sensing electrodes 141 along the first direction X, and a size of the plurality of third peripheral touch sensing electrodes 142c along the second direction Y can be smaller than the size of the plurality of central touch sensing electrodes 141 along the second direction Y. In at least one embodiment, the size of the plurality of third peripheral touch sensing electrodes 142c along the first direction X and the second direction Y is 1.5 micrometers.

The metal conducting layer 125 can be electrically coupled to the touch sensing layer 140 through a plurality of vias 1241 defined through the second insulating layer 124. The metal conducting layer 125 can include a plurality of metal conducting layer 1251. Each metal conducting line 1251 is electrically coupled to one corresponding central touch sensing electrode 141 or one corresponding peripheral touch sensing electrode 142. The plurality of central touch sensing electrodes 141 and the plurality of peripheral touch sensing electrodes 142 can electrically couple to the driving chip 170 through the plurality of metal conducting lines 1251. In at least one embodiment, the driving chip 170 can be mounted on the second substrate 120 through a chip on glass method or other suitable method. The driving chip 170 can transmit touch sensing signals and common voltage signals separately during separate time periods to the plurality of central touch sensing electrodes 141 and the plurality of peripheral touch sensing electrodes 142. The plurality of touch sensing electrodes, upon receiving the touch sensing signals, operates in the touch sensing mode. The plurality of touch sensing electrodes, upon receiving the common voltage signals, operates in the display mode.

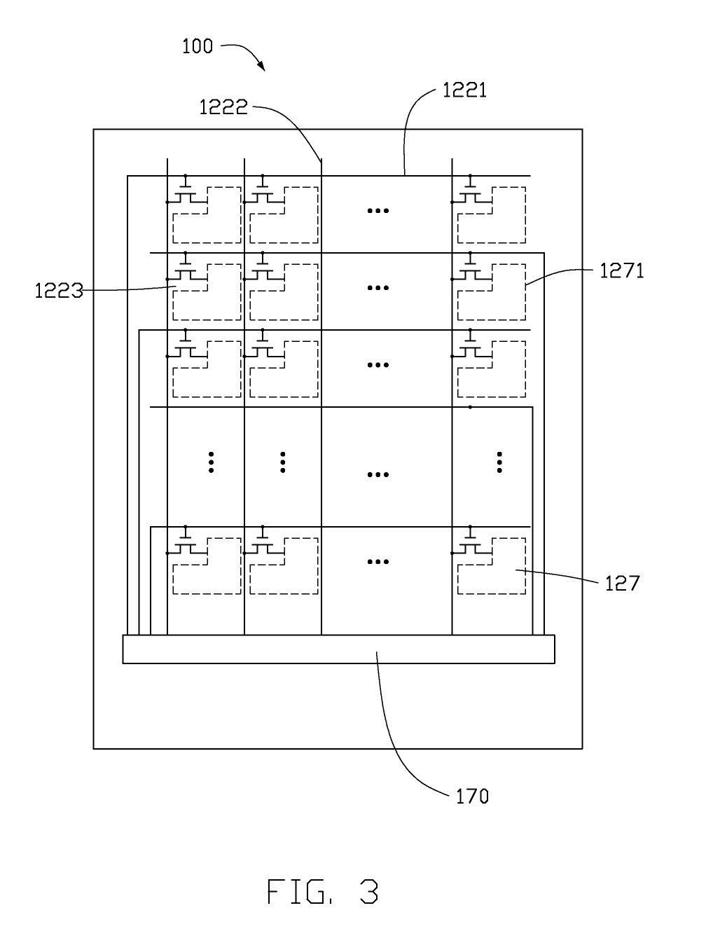

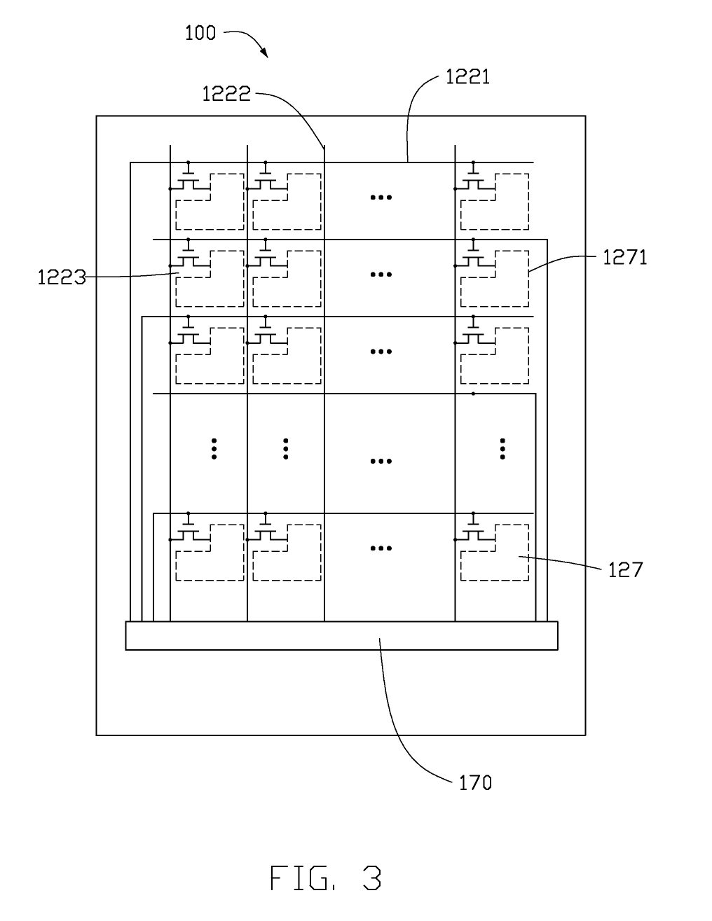

As illustrated in FIG. 3, the thin film transistor driving layer 122 can include a plurality of scan lines 1221 extending along the first direction X, a plurality of data lines 1222 extending along the second direction Y, and a plurality of thin film transistors 1223. The plurality of scan lines 1221 can electrically couple the driving chip 170 to corresponding gate electrodes of the thin film transistors 1223. The plurality of data lines 1222 can electrically couple the driving chip 170 to corresponding source electrodes of the thin film transistors 1223. The pixel electrode layer 127 can include a plurality of pixel electrodes 1271 arranged in a matrix. The pixel electrodes 1271 can be electrically coupled to corresponding data electrodes of the thin film transistors 1223. In at least one embodiment, the plurality of data electrodes can be electrically coupled to the plurality of pixel electrodes through a plurality of vias (not shown) defined through the first insulating layer 123, the second insulating layer 124, and the third insulating layer 126. The driving chip 170 can control the thin film transistors 1223 when the plurality of touch sensing electrodes operates in the display mode.

The plurality of peripheral touch sensing electrodes 142 is smaller in size than the plurality of central touch sensing electrodes 141. Thus, a sensitivity and accuracy of detecting touch operations thereon is improved.

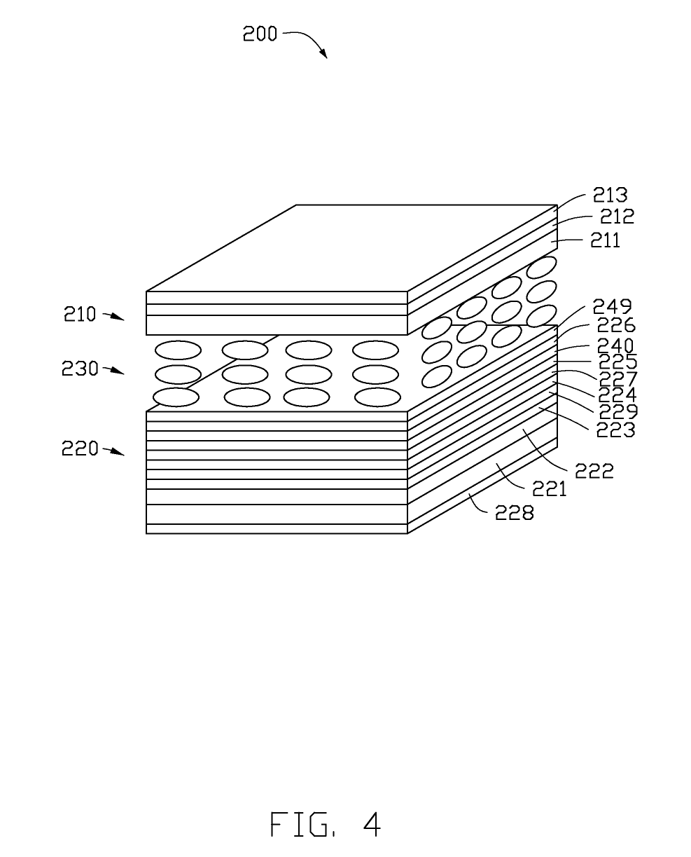

FIG. 4 illustrates a second embodiment of an embedded touch display panel 200. The embedded touch display panel 200 can include a first substrate 210, a second substrate 220, and a liquid crystal layer 230. The liquid crystal layer 230 can be located between the first substrate 210 and the second substrate 220. In at least one embodiment, the first substrate 210 is a color filter substrate, and the second substrate 220 is a thin film transistor substrate. The second substrate 220 can include a touch sensing layer 240.

The first substrate 210 can include a first base layer 211, a color filter layer 212, and a first polarizing layer 213. The color filter layer 212 can be located on a side of the first substrate 210 facing away from the liquid crystal layer 230. The first polarizing layer 213 can be located on a side of the color filter layer 212 facing away from the liquid crystal layer 230.

The second substrate 220 can include a second base layer 221, a thin film transistor driving layer 222, a first insulating layer 223, a common electrode layer 229, a second insulating layer 224, a pixel electrode layer 227, a third insulating layer 225, a fourth insulating layer 226, a metal conducting layer 249, and a second polarizing layer 228.

The thin film transistor driving layer 222 can be located on a side of the second base layer 221 facing the liquid crystal layer 230. The first insulating layer 223 can be located on a side of the thin film transistor driving layer 222 facing the liquid crystal layer 230. The common electrode layer 229 can be located on a side of the first insulating layer 223 facing the liquid crystal layer 230 and electrically insulated from the thin film transistor driving layer 222 through the first insulating layer 223. The second insulating layer 224 can be located on a side of the common electrode layer 229 facing the liquid crystal layer 130. The pixel electrode layer 227 can be located on a side of the second insulating layer 224 facing the liquid crystal layer 230 and electrically insulated from the common electrode layer 229 through the second insulating layer 224. The third insulating layer 225 can be located between the pixel electrode layer 227 and the touch sensing layer 240 and electrically insulate the touch sensing layer 240 from the pixel electrode layer 227. The fourth insulating layer 226 can be located on a side of the touch sensing layer 240 facing the liquid crystal layer 230. The metal conducting layer 249 can be located on a side of the fourth insulating layer 226 facing the liquid crystal layer 230 and be electrically insulated from the touch sensing layer 240 through the fourth insulating layer 226. The second polarizing layer 228 can be located on a side of the second base layer 221 facing away from the liquid crystal layer 230.

The embedded touch display panel 200 can be substantially similar to the embedded touch display panel 100. The difference is that the embedded touch display panel 200 includes the common electrode layer 229, so the plurality of touch sensing electrodes of the touch sensing layer 240 only operate in the touch sensing mode. The common electrode layer 229 can be controlled by a corresponding driving chip (not shown) to cooperate with the pixel electrode layer 227 to drive the liquid crystal layer 230 to display.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An embedded touch display panel comprising:
a touch sensing layer; and
a plurality of touch sensing electrodes arranged in the touch sensing layer of the embedded touch display panel, the plurality of touch sensing electrodes comprising:
a plurality of central touch sensing electrodes arranged in a central portion of a display area of the embedded touch display panel; and
a plurality of peripheral touch sensing electrodes arranged in a peripheral portion of the display area of the embedded touch display panel, the peripheral portion surrounding the central portion, and the plurality of peripheral touch sensing electrodes being smaller in size than the plurality of central touch sensing electrodes.

2. The embedded touch display panel as in claim 1 comprising a driving chip positioned in a non-display area of the embedded touch display panel and electrically coupled to the plurality of touch sensing electrodes.

3. The embedded touch display panel as in claim 2, wherein:
the embedded touch display panel comprises a first substrate, a second substrate, and a liquid crystal layer, the liquid crystal layer located between the first substrate and the second substrate; and
the touch sensing layer is located in the second substrate.

4. The embedded touch display panel as in claim 3, wherein:
the plurality of central touch sensing electrodes is arranged in a matrix as a plurality of rows and columns;
the plurality of rows is arranged along a first direction; and
the plurality of columns is arranged along a second direction.

5. The embedded touch display panel as in claim 4, wherein:
the plurality of peripheral touch sensing electrodes comprises a plurality of first peripheral touch sensing electrodes arranged along the first direction; and
a size of the plurality of first peripheral touch sensing electrodes along the first direction is smaller than a size of the plurality of central touch sensing electrodes along the first direction.

6. The embedded touch display panel as in claim 5, wherein a size of the plurality of first peripheral touch sensing electrodes along the second direction is equal to a size of the plurality of central touch sensing electrodes along the second direction.

7. The embedded touch display panel as in claim 5, wherein the plurality of first peripheral touch sensing electrodes is arranged along the same rows as the plurality of central touch sensing electrodes.

8. The embedded touch display panel as in claim 5, wherein;
a distance between every two adjacent central touch sensing electrodes is the same; and
the distance between every two adjacent central touch sensing electrodes is larger than a distance between the plurality of first peripheral touch sensing electrodes and the central touch sensing electrode located most adjacent to the first peripheral touch sensing electrodes.

9. The embedded touch display panel as in claim 5, wherein:
the plurality of peripheral touch sensing electrodes comprises a plurality of second peripheral touch sensing electrodes arranged along the second direction; and
a size of the plurality of second peripheral touch sensing electrodes along the second direction is smaller than a size of the plurality of central touch sensing electrodes along the second direction.

10. The embedded touch display panel as in claim 9, wherein a size of the plurality of second peripheral touch sensing electrodes along the first direction is equal to a size of the plurality of central touch sensing electrodes along the first direction.

11. The embedded touch display panel as in claim 9, wherein the plurality of second peripheral touch sensing electrodes is arranged along the same columns as the plurality of central touch sensing electrodes.

12. The embedded touch display panel as in claim 9, wherein:
a distance between every two adjacent central touch sensing electrodes is the same; and
the distance between every two adjacent central touch sensing electrodes is larger than a distance between the plurality of second peripheral touch sensing electrodes and the central touch sensing electrode located most adjacent to the second peripheral touch sensing electrodes.

13. The embedded touch display panel as in claim 9, wherein:
the plurality of peripheral touch sensing electrodes comprises a plurality of third peripheral touch sensing electrodes arranged in the corners of the peripheral display area;
a size of the plurality of third peripheral touch sensing electrodes along the first direction is smaller than the size of the plurality of central touch sensing electrodes along the first direction; and
a size of the plurality of third peripheral touch sensing electrodes along the second direction is small than the size of the plurality of central touch sensing electrodes along the second direction.

14. The embedded touch display panel as in claim 13, wherein:
the size of the plurality of third peripheral touch sensing electrodes along the first direction is equal to the size of the plurality of first peripheral touch sensing electrodes along the first direction; and
the size of the plurality of third peripheral touch sensing electrodes along the second direction is equal to the size of the plurality of second peripheral touch sensing electrodes along the second direction.

15. The embedded touch display panel as in claim 14, wherein:
the thin film transistor driving layer comprises a plurality of scan lines, a plurality of data lines, and a plurality of thin film transistors;
the plurality of scan lines extend along the first direction and electrically couple the driving chip to corresponding gate electrodes of the plurality of thin film transistors;
the plurality of data lines extend along the second direction and electrically couple the driving chip to corresponding source electrodes of the plurality of thin film transistors;
the pixel electrode layer comprises a plurality of pixel electrodes arranged in a matrix;
drain electrodes of the plurality of thin film transistors are electrically coupled to corresponding pixel electrodes through the first insulating layer, the second insulating layer, and the third insulating layer;

16. The embedded touch display panel as in claim 15, wherein the first substrate comprises:
a first base layer;
a color filter layer located on a side of the first base layer facing away from the liquid crystal layer; and
a first polarizing layer located on a side of the color filter layer facing away from the liquid crystal layer;

17. The embedded touch display panel as in claim 16, wherein the second substrate comprises:
a second base layer;
a thin film transistor driving layer located on a side of the second base layer facing the liquid crystal layer;
a first insulating layer located between the thin film transistor driving layer and the touch sensing layer and configured to electrically insulate the touch sensing layer from the thin film transistor driving layer;
a second insulating layer located on a side of the touch sensing layer facing the liquid crystal layer;
a metal conducting layer located on a side of the second insulating layer facing the liquid crystal layer and electrically insulated from the touch sensing layer through the second insulating layer;
a third insulating layer located on a side of the metal conducting layer facing the liquid crystal layer;
a pixel electrode layer located on a side of the third insulating layer facing the liquid crystal layer and electrically insulated from the metal conducting layer through the third insulating layer; and
a second polarizing layer located on a side of the second base layer facing away from the liquid crystal layer.

18. The embedded touch display panel as in claim 17, wherein:
the metal conducting layer comprises a plurality of metal conducting lines;
the metal conducting layer is electrically coupled to the touch sensing layer through the plurality of metal conducting lines passing through a plurality of vias defined through the second insulating layer;
each metal conducting line electrically couples to one corresponding central touch sensing electrode or one corresponding peripheral touch sensing electrode;
the central touch sensing electrodes and the peripheral touch sensing electrodes are electrically coupled to the driving chip through the plurality of metal conducting lines;
the driving chip is configured to transmit to the plurality of touch sensing electrodes touch sensing signals and common voltage signals separately during separate time periods;
the plurality of touch sensing electrodes, upon receiving the touch sensing signals, operate in a touch sensing mode to detect touch operations thereon; and
the plurality of touch sensing electrodes, upon receiving the common voltage signals, operate in a display mode for cooperating with the pixel electrode layer to drive the liquid crystal layer to display.

19. The embedded touch display panel as in claim 16, wherein the second substrate comprises:
a second base layer;
a thin film transistor driving layer located on a side of the second base layer facing the liquid crystal layer;
a first insulating layer located on a side of the thin film transistor driving layer facing the liquid crystal layer;
a common electrode layer located on a side of the first insulating layer facing the liquid crystal layer and electrically insulated from the thin film transistor driving layer through the first insulating layer;
a second insulating layer located on a side of the common electrode layer facing the liquid crystal layer;
a pixel electrode layer located on a side of the second insulating layer facing the liquid crystal layer and electrically insulated from the common electrode layer through the second insulating layer;
a third insulating layer located between the pixel electrode layer and the touch sensing layer and configured to electrically insulate the touch sensing layer from the pixel electrode layer;
a fourth insulating layer located on a side of the touch sensing layer facing the liquid crystal layer;
a metal conducting layer located on a side of the fourth insulating layer facing the liquid crystal layer and electrically insulated from the touch sensing layer through the fourth insulating layer; and
a second polarizing layer located on a side of the second base layer facing away from the liquid crystal layer.

20. The embedded touch display panel as in claim 19, wherein:
the metal conducting layer comprises a plurality of metal conducting lines;
the metal conducting layer is electrically coupled to the touch sensing layer through the plurality of metal conducting lines passing through a plurality of vias defined through the fourth insulating layer;
each metal conducting line electrically couples to one corresponding central touch sensing electrode or one corresponding peripheral touch sensing electrode;
the central touch sensing electrodes and the peripheral touch sensing electrodes are electrically coupled to the driving chip through the plurality of metal conducting lines;
the driving chip transmits touch sensing signals to the plurality of touch sensing electrodes to control the plurality of touch sensing electrodes to operate in a touch sensing mode to detect touch operations thereon; and
the driving chip is electrically coupled to the common electrode layer to control the common electrode layer to drive the liquid crystal layer to display.
